(19) United States
(12) Patent Application Publication
(10) Pub. No.: US 2025/0229585 A1
(43) Pub. Date: Jul. 17, 2025

(54) AUTONOMOUS VEHICLE RESPONSES TO TRAILER FIRES

(71) Applicant: Torc Robotics, Inc., Blacksburg, VA (US)

(72) Inventors: Joseph R. Fox-Rabinovitz, Blacksburg, VA (US); Armenio Rivero, Blacksburg, VA (US); Walter Grigg, Blacksburg, VA (US)

(21) Appl. No.: 18/410,132

(22) Filed: Jan. 11, 2024

(51) Int. Cl. B60D 1/62; B60D 1/01; B60D 1/36

(52) U.S. Cl. CPC B60D 1/62; B60D 1/015; B60D 1/36

(57) ABSTRACT

In one aspect, a vehicle includes a locking mechanism that is configured to removably secure to a trailer. A memory may store instructions, and one or more processors may be configured to access the memory and execute the instructions to: receive at least one signal used to determine that a potential fire condition is present on at least one of the trailer or the vehicle, and in response to the at least one signal, automatically initiate unlocking the locking mechanism to disconnect the trailer, and initiate driving a distance away from the trailer.

### TECHNICAL FIELD

The field of the disclosure relates generally to automobile fire response technologies, and more particularly, to a system and associated method of responding to fire conditions in an autonomous vehicle or semi-autonomous vehicle.

### BACKGROUND

Tractor trailer fires are potentially hazardous and costly occurrences. While uncommon, a fire in a trailer may be caused by frictional forces in brakes, bearings, tires, as well as by over-application of oil to high-friction components, or leakage of oil into high-friction areas. Signs and conditions leading up to a fire can be difficult for even a seasoned driver of a non-autonomous vehicle to discern. Quick decisions and decisive action can minimize danger and damage. For instance, the driver must take several actions in the moments following a detected fire. Such actions may include the driver exiting the cab to determine if it is safe to approach and visually assess the trailer. Where possible and warranted, the driver may be able to pull a kingpin of a fifth wheel assembly to release the trailer from the tractor. This manual release may allow the driver to pull forward from under a burning trailer. More particularly, the tractor is typically able to move a safe distance before the brakes of the tractor and trailer are locked up. Those brakes may become locked when air hoses are damaged (e.g., ripped away), emptying the air reservoir of the tractor as it pulls away. While autonomous vehicles inherently eliminate danger to a tractor trailer driver, challenges remain in how to replace the remediating human intervention. Accordingly, there is a need for improvement in means for autonomous vehicles to response to fire conditions.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle includes a locking mechanism configured to removably secure to a trailer configured to be towed and a memory storing instructions. One or more processors may be configured to access the memory and execute the instructions to: receive at least one signal used to determine that a potential fire condition is present on at least one of the trailers or the tractor, and in response to the at least one signal, automatically initiate unlocking the locking mechanism to disconnect the trailer, and initiate driving a distance away from the trailer.

In another aspect, a method of responding to a potential trailer fire condition includes removably securing a trailer using a locking mechanism, determining that a potential fire condition is present based on received sensor data, in response to the determination, automatically initiating unlocking the locking mechanism to disconnect the trailer and initiating driving a distance away from the trailer.

In another aspect, at least one non-transitory computer-readable storage medium with instructions stored thereon may, in response to execution by at least one processor, cause the at least one processor to: determine that a potential fire condition is present based on received sensor data, and in response to the determination, automatically initiate unlocking a locking mechanism connecting a trailer to be towed, and initiate driving a distance away from the trailer.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of a vehicle such as a truck that includes a fire response system of an exemplary embodiment of the present disclosure.

FIG. 2 is an exemplary schematic block diagram of a computing device for implementation of embodiments of the present disclosure.

FIG. 3 is a block diagram showing illustrative components of a fire response system juxtaposed with an outline of an autonomous or semi-autonomous vehicle.

FIG. 4 is a block diagram of an embodiment of a system configured to in response to a fire condition, selectively initiate the release of the trailer from the vehicle by automatically actuating a locking mechanism.

FIG. 5 depicts an example of a fifth-wheel hitch as viewed from a first perspective in accordance with present implementations.

FIG. 6 depicts the fifth-wheel hitch physically attached to a vehicle from a second perspective, in accordance with present implementations.

FIG. 7 is a flow diagram illustrating an embodiment of a method of performing fire control processes in response to detecting a fire or imminent threat of fire as may be performed by the systems of the preceding figures.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

An implementation of the system may minimize damage to an autonomous tractor, or semi-truck, while facilitating the safety of surrounding drivers. In some implementations, a final decision to perform a maneuver to release a trailer from the tractor may be performed by a human at mission control. For instance, the semi-truck may send relevant sensor information to a mission control towards determining the probability of a tip-over when the tractor is removed from beneath the trailer.

Relevant information used in the determination may include visual data, such as live streamed video or other photographic images. Other illustrative image data may include imagery of the trailer wheelbase in visible and non-visible spectra (e.g. infrared (IR)) to show a progression of a fire. Other data may include readings from an inertial measurement unit (IMU) which can measure the orientation of the vehicle, including an angle at which it is tipped. Other data uploaded to the mission control may include estimates of the vertical and lateral center of mass of the trailer to determine a relative probability of a tip-over. Another potential input communicated to mission control may include a weight of the trailer on tractor air pads to indicate a lateral pressure difference. Other factors addressed by uploaded data may include a video feed of surrounding road conditions to indicate a potential danger from a possible fire spread. While decisions based on the data may be performed at mission control, another implementation may perform some or all of the trailer release decisions automatically using the processors present onboard the autonomous vehicle.

In a particular implementation, powered landing may be installed on the trailer in a manner that may be controlled by the autonomous driving circuitry. Deployment of the powered landing gear may facilitate the subsequent mechanical disconnection between the tractor and trailer, while providing improved stability for the disconnected trailer. This action may be initiated in some instances without prior approval from mission control. In another implementation, dropping the landing gear may be unavailable or undesirable, so the mechanical disconnect is performed without it.

An implementation may make use of existing hardware, such as cameras and other sensors typically present in autonomous semi-trucks. For instance, a rearwards facing IR sensor positioned proximate the middle and back of a tractor may be used to detect heat anomalies. A smoke detector and an acoustic detector may additionally be positioned near the back surface of a semi-truck cab to monitor for indications of a fire or precursor to a fire event. Accelerometers and other vibration sensors may detect grinding or other vibrations. Irregular vibrations generally indicate undesired friction occurring at a malfunctioning part or system. Different vibrational frequencies may be associated with different types of mechanical failures. As such, a model may be trained with data to identify and catalogue if a sensed vibration is consistently associated with a particular malfunction, such as a broken bearing or the effects of over-application of oil to high-friction components, or leakage of oil into high-friction areas. A table including a range of frequencies each logically linked to different potential malfunctions may be accessed by the processor(s) to identify an imminent fire hazard. While sensors described herein may be primarily positioned on or within the tractor, itself, other embodiments may include sensors that originate and communicate readings signals from the trailer.

Where so configured, an implementation may upload real-time data to a manned mission control room. The mission control may make decisions regarding the fire response, including overriding a recommendation from the processors of the autonomous vehicle. In some instances, the decision at mission control may be made by a human being. In either case, the mission control may be presented with video, sensor data, road conditions, cargo listings, weight data, surrounding traffic information, speed, and geographic coordinates, among other inputs. The grade, road material, and evenness of the road may comprise additional factors used to calculate a probability of the trailer tipping under present conditions. Such data may factor into the decision as to how to react to a potential fire scenario. While mission control may have such a final authority in some embodiments, others may use the onboard processing system to make the response systems-exclusively or in the absence of an immediate response from mission control.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

A smart vehicle: A smart vehicle is a vehicle installed with on-board computing devices, one or more sensors, one or more controllers, and/or one or more internet-of-things (IoT) devices which enables the vehicle to receive and/or transmit data to another vehicle and/or a server.

Mission control: Mission control, also referenced herein as a centralized or regionalized control, is a hub in communication with one or more autonomous vehicles of a fleet. Human agents, or artificial intelligence based agents, positioned at mission control may monitor data or service requests received from the autonomous vehicle and may dispatch a rescue vehicle (also referenced herein as a service vehicle) at the autonomous vehicle's location.

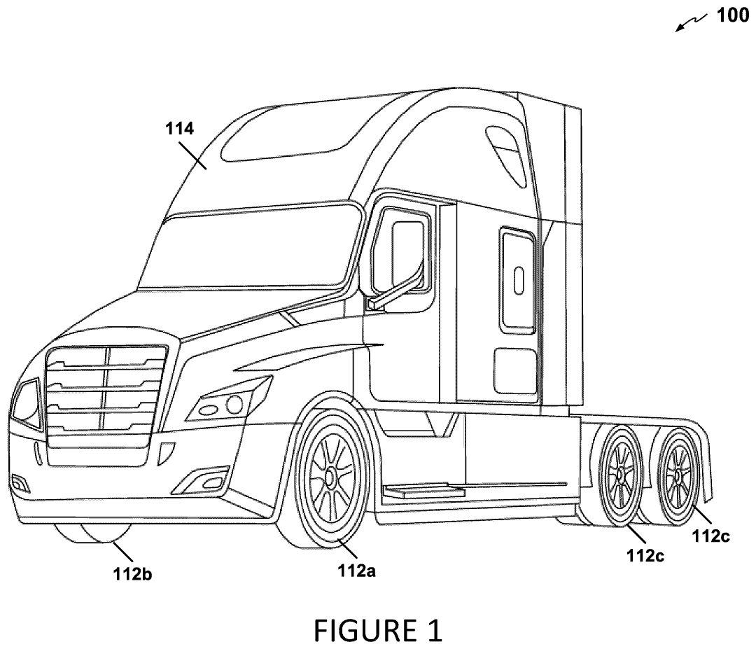

FIG. 1 illustrates a vehicle 100 which may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel and the steering column may be omitted in an autonomous vehicle.

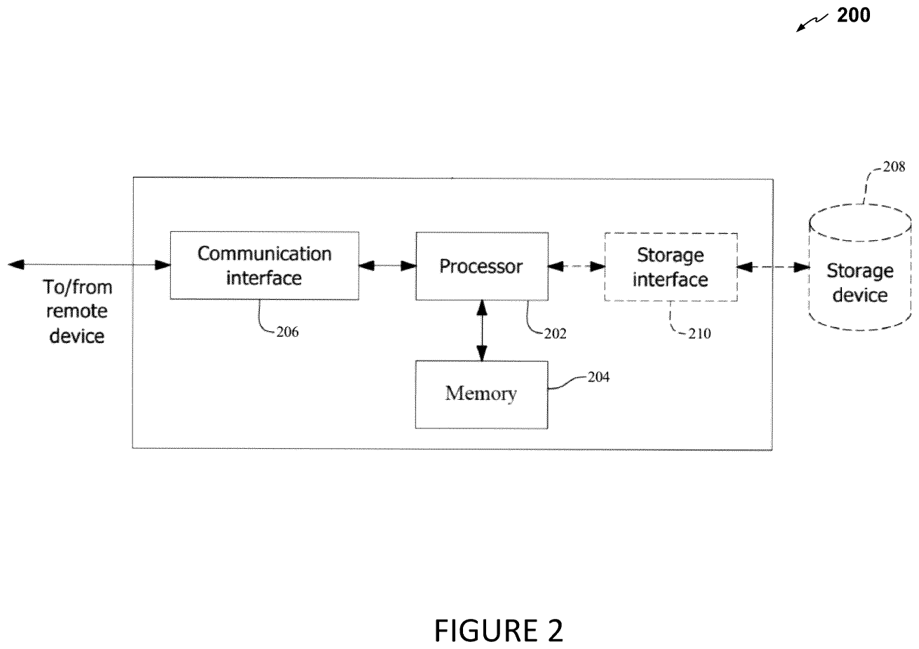

FIG. 2 is an exemplary schematic block diagram of a computing device 200 for implementation of embodiments of the present disclosure. The computing device 200 may include the automated fire response system described herein. The computing device 200 may include one or more processing units or processors 202 (e.g., in a multi-core configuration). Processor 202 may be operatively coupled to a communication interface 206 such that the computing device 200 is capable of communicating with another device, such as a remote application server, a user equipment, a mobile device, a smart vehicle, a mission control or a central hub, or another computing device, for example, using wireless communication or data transmission over one or more radio links or digital communication channels using one or more of a Wi-Fi protocol, an RFID protocol, a Near-Field Communication (NFC) protocol, Blue Tooth, 3G. 4G. 5G, or 6G, for example, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the computing device 200. For example, the computing device 200 may include one or more hard disk drives as storage device 208.

In other embodiments, storage device 208 may be external to the computing device 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

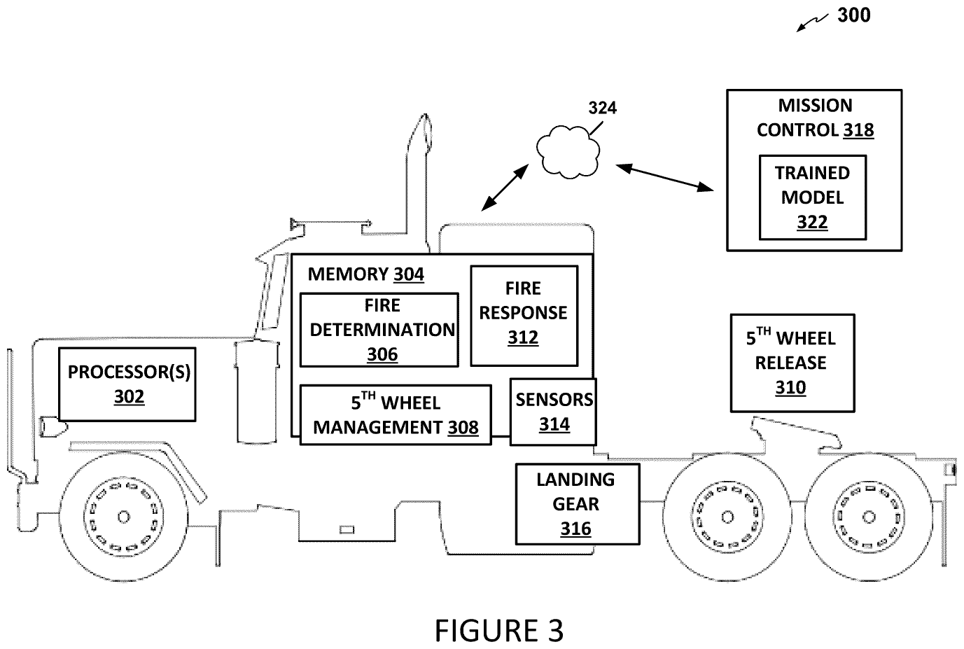

FIG. 3 is a block diagram showing illustrative components of a fire response system 300 juxtaposed with an outline of an autonomous or semi-autonomous vehicle. The system 300 includes one or more processors 302 in communication with a memory 304. While the processors 302 and memory 304 are depicted as being included within the autonomous truck, the processors and memory of another implementation, as well as their related functions may be spread out in remote systems. For instance, a mission control center 318 may communicate instructions and data via a wireless connection 324.

The memory 304 includes instructions (i.e., modules, or algorithms) executable by the processor 302 to monitor and respond to fire conditions. For instance, a fire determination module 306 may receive inputs from sensors 314 to ascertain if a fire is present or imminent. For instance, the sensor module 314 may receive live streamed video, including IR imagery. Other sensor may input data communicating weights, pressures and information surrounding road conditions and traffic.

As described herein, such data may be communicated to the processors 302, and in some implementations, the mission control center 318. Sensor inputs and fire response outcomes may be used to train a machine learning model 322 to assist in future response decisions. For instance, the model 322 may be trained with data to identify and catalogue if a sensed vibration is consistently associated with a particular malfunction. Thus, sensor signals may be linked to different potential malfunctions used to identify an imminent fire hazard.

A fire response module 312 may initiate actions to address or remediate a detected fire condition. For instance, the fire response model may communicate with the mission control center 318 before or after initiating other automated actions. An example of a directed (or in other embodiments, completely autonomous action) may include determining whether the landing gear 316 should be deployed. Prior to this action, the fire response module 312 may determine the most safe and efficient manner to pull over and stop the autonomous vehicle and trailer based on various, weighted internal and external inputs. A tailer release decision may include automatically cause the release pion of the fifth wheel release module 310 to be moved from a position of securing the trailer to the tractor.

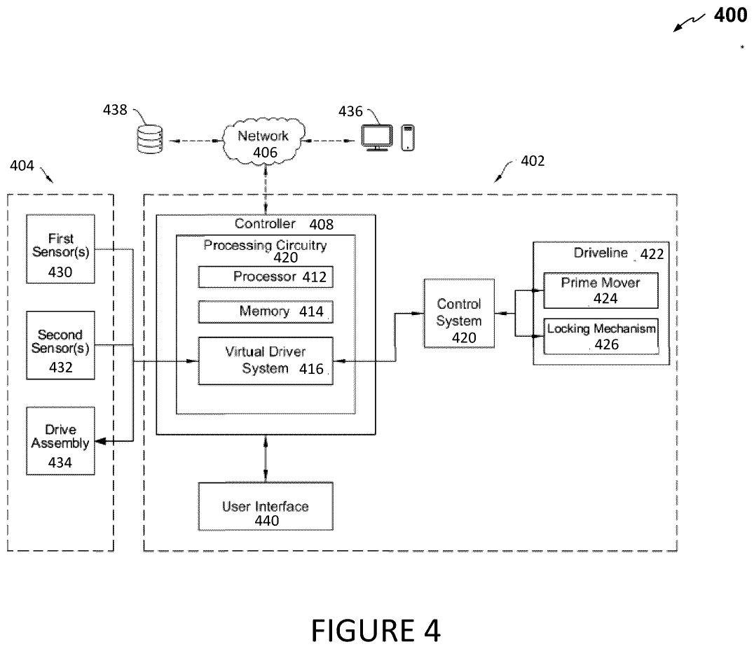

Regarding the fifth wheel release function, FIG. 4 is a block diagram of an embodiment of a system 400 configured to in response to a fire condition, selectively initiate the release of the trailer from the vehicle 402 by automatically actuating a locking mechanism 426. The management system 400 may include the vehicle 402 a coupling receiver 404, and a network 406. The vehicle 402 may include a controller 408, a control system 420, and a driveline 422. In some examples, the vehicle 402 is an autonomous tractor trailer.

As will be described in detail herein, the control system 420 may be used to control the operation and operating parameters of the driveline 422. The driveline 422 may comprise a prime mover 424 and a locking mechanism 426. The coupling receiver 404 may include, among other things, one or more first sensors 430, one or more second sensors 432, and a drive assembly 434. The network 406 may be communicably coupled to the vehicle 402 by way of the controller 408. The controller 408 may include a network interface to facilitate receiving data from, and transmitting data to, network 406. Network 406 may also be communicatively coupled to a remote user device 436 and/or a database 438.

While this disclosure refers to a vehicle 402 (e.g., a tractor trailer) as an autonomous vehicle, it is understood that the vehicle 402 could be any type of vehicle including an automobile, a mobile industrial machine, etc. While the disclosure will discuss a self-driving or driverless autonomous system, it is understood that the autonomous system could alternatively be semi-autonomous having varying degrees of autonomy or autonomous functionality.

Controller 408 may comprise processing circuitry 410, the processing circuitry 410 including a processor 412, a memory 414, and a virtual driver system 416. The processor 412 of controller 408 may be embodied as one or more of a data processor, a microcontroller, a microprocessor, a digital signal processor, a logic circuit, a programmable logic array, or one or more other devices for controlling the automatic hitch-position system 400 in response to one or more of the system inputs. Automatic hitch-position system 400 may include a single microprocessor or multiple microprocessors that may include means for identifying and reacting to various engagement statuses of coupling receiver 404, as transmitted by sensors 430 and 432 or drive assembly 434. Numerous commercially available microprocessors can be configured to perform the functions of the automatic hitch-position system 400. It should be appreciated that automatic hitch-position system 400 could include a general machine controller capable of controlling numerous other machine functions. Alternatively, a special-purpose machine controller could be provided. Further, the automatic hitch-position system 400, or portions thereof, may be located remote from the automatic hitch-position system 400, such as at database 438 or remote user device 436. Various other known circuits may be associated with the automatic hitch-position system 400, including signal-conditioning circuitry, communication circuitry, actuation circuitry, and other appropriate circuitry.

The processor 412 may be a device that performs mathematical operations and logical operations on data. In some examples, it is an electronic circuit that receives input data, processes it, and produces output data. The processor 412 may consist of a central processing unit (CPU), which performs the calculations, and other supporting circuits, such as memory 414, virtual driver system 416, user interface 440, and bus controllers.

The CPU may be responsible for executing instructions. It consists of an arithmetic logic unit (ALU) that performs arithmetic and logical operations, and a control unit (CU) that controls the flow of instructions and data within the processor. The ALU performs operations such as addition, subtraction, multiplication, division, and logical operations like AND, OR, and NOT. The CU fetches instructions from memory 414, decodes them, and executes them.

The user interface 440 enable the processor 412 to communicate with other devices, such as keyboards, displays, storage devices, sensors 430, 432, drive assembly 434, control system 420, and network 406. These interfaces use protocols such as USB, Ethernet, and Wi-Fi to transfer data to and from the processor. The bus controllers manage the flow of data between the CPU, memory 414, and input/output interfaces (e.g., user interface 440). They ensure that data is transferred efficiently and that multiple devices can share the same bus without interfering with each other. The processor 412 may also include memory, which stores data and instructions that the processor 412 accesses during its operation. This memory can be volatile, like random-access memory (RAM), which loses data when power is turned off, or non-volatile, like read-only memory (ROM), which retains data even when power is turned off.

The memory 414 of automatic hitch-position system 400 may be integrated into processor 412, or simply be communicably coupled to processor 412. Memory 414 may store data and/or software routines that may assist the automatic hitch-position system 400 in performing its functions, such as the functions of the virtual driver system 416. Further, the memory 414 may also store data received from various inputs associated with the automatic hitch-position system 400, such as data from the one or more first sensors 430, one or more second sensors 432, and drive assembly 434.

The virtual driver system 416 may be embodied as a module, unit, system, or instructions to be executed by the processor 412. The virtual driver system 416 may be stored in memory 414 and, when executed, cause the processor to perform various functions, including the steps and methods of the automatic hitch-position system 400.

According to some examples, the virtual driver system 416 receives inputs from the first sensor(s) 430, second sensor(s) 432, drive assembly 434, remote user device 436, control system 120, and driveline 422. Additionally, the virtual driver system 416 may receive inputs from a local operator or user through user interface 440 housed in vehicle 402. For example, vehicle 402 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc. These input devices may be used by the operator of vehicle 402 to interact with the vehicle 402 and control the virtual driver system 416 and/or controller 408.

According to some examples, the virtual driver system 416 receives sensor data from first sensor(s) 430, the second sensor(s) 432, and drive assembly 434. In some examples, the first sensor(s) 430, the second sensor(s) 432, and drive assembly 434 are cooperatively coupled to the coupling receiver 404, the coupling receiver 404 being further described herein. Sensor 430, 432 may be any sensor used to determine the presence of an object. In some examples, the sensors 430, 132 may be used to detect the presence of a metal object (e.g., a trailer kingpin).

There are various sensors available that can detect the presence of metal in proximity, such as may be used for one or more of the first sensors 430, one or more of the second sensors 432, or one or more of both the first and the second sensors 430, 432. In some implementations, however, the various sensors (e.g., one or more of the first sensors 430 and/or one or more of the second sensors 432) may be configured to detect the position of the fifth-wheel hitch, yet they may each work in different ways to sense whether any metal objects, such as the fifth-wheel hitch, are present nearby.

For example, inductive proximity sensors use electromagnetic fields to detect the presence of metal within their sensing range. Inductive proximity sensors have various benefits in the present disclosures, including their ability to operate in a variety of working environments in which they are exposed to dirt, grease, grime, and other adverse conditions that may be present during operation of the system 400 (e.g., conditions commonly associated with commercial tractor trailers). For example, the functionality of the one or more first and second sensors can avoid appreciably decreasing with the presence of these external elements and adverse conditions. In some examples, one or more of the first and/or second sensors 430, 432 may be used to detect the presence of metals and various alloys through the electromagnetic field associated with those materials and that the one or more of the sensors 430, 432 may be configured to detect.

In some examples, one or more Hall-effect sensors can be used (e.g., as one or more of the first and/or second sensor(s) 430, 432) to detect changes in the magnetic field detected by the Hall-effect sensor(s), which is caused by a metal object disposed within the magnetic field sensed by the Hall-effect sensor. In some examples, therefore, one or more Hall-effect sensors may be configured to detect the position of the fifth-wheel hitch by detecting whether any changes in the magnetic field have been caused by a nearby magnet, or a current-carrying conductor, positioned on, or fastened to, the fifth-wheel hitch (e.g., one or more magnets disposed on the fifth-wheel hitch and configured to enable the hall-effect sensor(s) to detect when the fifth-wheel hitch is near any of the Hall-effect sensor(s)). In some examples, the one or more Hall-effect sensor(s) include a thin rectangular semiconductor material with a small strip of metal on one side, which acts as the sensor's contact surface and can be mounted, for example, near one of the notches 514 of the fifth-wheel hitch 500.

For those example, when a magnetic field is present close to the semiconductor material and the metal strip, it causes a buildup of charge carriers on one side of the semiconductor and a corresponding depletion of charge carriers on the opposite side. The resulting voltage difference between the two sides of the semiconductor can be, for example, proportional to the strength of the magnetic field. The voltage difference can be measured by the Hall-effect sensor(s) to detect whether a magnetic field is present and, if so, its strength (e.g., whether the strength of the magnetic field exceeds a threshold used to determine whether the sensor output is “positive” or “negative”).

In some examples, either of the first sensor(s) 430 or the second sensor(s) 432, or both, can include one or more magnetic sensors configured to detect changes in magnetic fields caused by metal objects present within a sensor's vicinity. The one or more magnetic sensors can be configured to detect a position of the fifth-wheel hitch by detecting any changes in a sensor's magnetic field. For example, the one or more magnetic sensors can be configured to detect changes in a magnetic field caused by any nearby magnetic, or ferromagnetic, materials. Each of the one or more magnetic sensors may further comprise a magnetic field sensor and supporting signal processing electronics (e.g., processor 412) to provide, based on the measurements of nearby magnetic fields, the sensor output. More specifically, when a magnetic or ferromagnetic material is present within the sensing range of the sensor, it causes a change in the magnetic field, which is detected by the magnetic field sensor. The sensor then converts this change in magnetic field into an electrical signal, which is processed by the supporting electronics. In some examples, one or more different methods can be used to detect the changes in the magnetic field and, as a result, the corresponding position of the fifth-wheel hitch. In some examples, the methods used to detect the changes in a magnetic field can depend on the type of magnetic sensor(s) used. For example, one implementation may include one or more magnetic sensors configured to detect the position of the fifth-wheel hitch with magnetoresistive elements, which have an electrical resistance that changes in the presence of a magnetic field and enables, as a result, measuring the magnetic field with the voltage corresponding to the resistance of the magnetoresistive elements.

In some examples, either the first or second sensor(s) 430, 432, or both, may include one or more ultrasonic sensors, which are configured to detect the position of the fifth-wheel hitch based on measurements of high-frequency sound waves. In those examples, the one or more ultrasonic sensors may be configured to detect the position of the fifth-wheel hitch based on measurements of high-frequency sound waves that will bounce off the fifth-wheel hitch if it is near one of the ultrasonic sensors. In some examples, the sensors 430, 432 may include one or more ultrasonic sensors that are each fixedly positioned at one of the notches used to position the fifth-wheel hitch.

In some examples, each of the one or more ultrasonic sensors may be configured to detect the position (and/or configuration) of the fifth-wheel hitch based on measurements of ultrasonic sound waves that will reflect back towards the sensor if an object is present nearby. In some examples, each of the one or more ultrasonic sensor(s) can determine whether the fifth-wheel hitch is positioned at that sensor by determining whether the measured distance between the sensor and the fifth-wheel hitch does not exceed a threshold value. For example, the sensor may determine that the fifth-wheel hitch is not positioned at the location of that sensor if the distance between the sensor and the hitch is greater than a centimeter (e.g., 2 centimeters/0.8 inches) or, in other examples, 0.50 centimeters (i.e., about 2 inches). The specific threshold value, however, is not limited to these examples and it may be any value suitable for detecting the position of a fifth-wheel hitch. In some examples, the one or more ultrasonic sensors (e.g., of the first and/or second sensors 430, 432) may operate in different modes, including, for example, a continuous mode where the sensor continually emit sound waves to detect any objects in their path; and, alternatively, pulse mode where the sensor only emits sound waves, or detects objects, at set intervals (e.g., every ten seconds, every 30 seconds, every ten minutes, or once when the vehicle 402 begins its operation, etc.). In addition, in some examples, the first and second sensors 430, 432 may include any type of direct distance measurement sensor, such as one or more laser range finders, stereo cameras, LiDAR, RADAR, and the like, and may include detecting position of the fifth-wheel hitch via image processing on a single camera image of a fixed object with a reference point (e.g., processing a single camera image to determine the angular size of a fixed object on the fifth-wheel hitch within the reference frame of the vehicle 102).

In some examples, the one or more first sensors 430 and the one or more second sensors 132 may all comprise the same (e.g., a single) type of sensor. In some examples, however, one or more of the first sensor(s) 430, one or more of the second sensor(s) 432, both the first and the second sensor(s) 430, 432, and including one or more of any sensor(s) associated with the drive assembly 434, may include any number of different sensors or types of sensors. For example, one or more of the first sensor(s) 430 may be an inductive proximity sensor(s), capacitive sensor(s), and distance measurement sensor(s) and, at the same time, one or more of the second sensors 432 may be a Hall-effect sensor and another sensor of the second sensors 432 may be an optical sensor. In some examples, therefore, one or more of the first sensor(s) 430 may be different types of sensors (e.g., the first sensor(s) 430 may include one or more capacitive sensors and one or more Hall-effect sensors). Similarly, some examples may include one or more second sensor(s) 432 that are different types of sensors. In some implementations, therefore, the first sensors 430, the second sensors 432, or both, may comprise any number sensors that may each be any type of sensor, which is configured for a system to automatically manage (e.g., detect and control) the configuration of a fifth-wheel hitch.

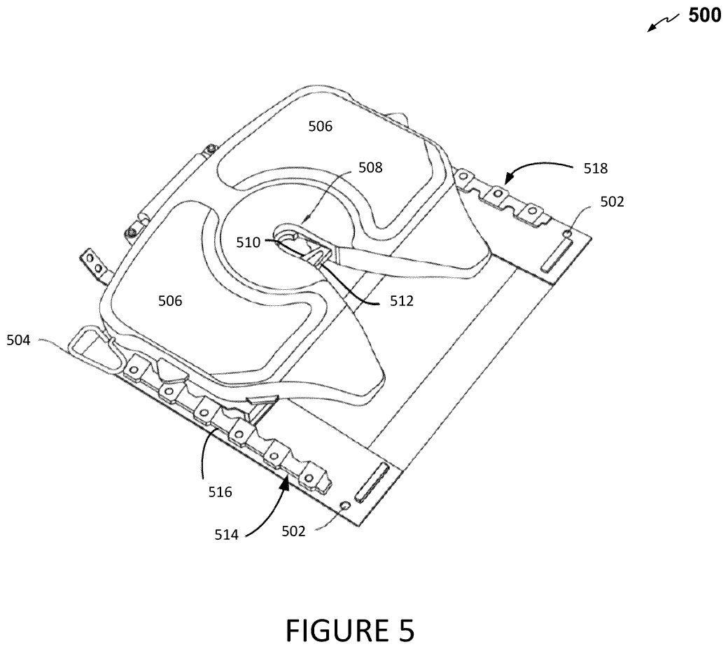

In some examples, the first sensor(s) 430 are configured to sense the position of a fifth-wheel hitch, or coupling receiver 404, that is configured to receive a coupling unit. The coupling unit, in some implementations, is a kingpin of trailer, which can be coupled with, or physically connected to, the fifth-wheel hitch of a vehicle (e.g., with the fifth-wheel hitches shown in FIG. 5). The coupling receiver 404 (e.g., including, but not limited to, a fifth-wheel hitch) is configured to receive the coupling unit and lock it in place. In some examples, and as described above, the coupling receiver 404 may be or it may include a fifth-wheel hitch of a tractor trailer (e.g., the examples of fifth-wheel hitches shown in FIG. 5. In some examples, the coupling receiver 404 may be, or may include one or more of a ball hitch, a pintle hitch, a gooseneck hitch, a weight distribution hitch, a bumper hitch, a tow bar, and a tow hook. The one or more second sensor(s) 432 may be configured detect the position of the coupling receiver 404 and may, in some examples, be configured to detect whether the position of the coupling receiver 404 has been locked by the locking mechanism 426, which may include detecting whether the coupling receiver 404 has locked the position of, or has physically secured a connection with, the coupling unit (e.g., the kingpin of a trailer), as further described below and with reference to FIG. 5.

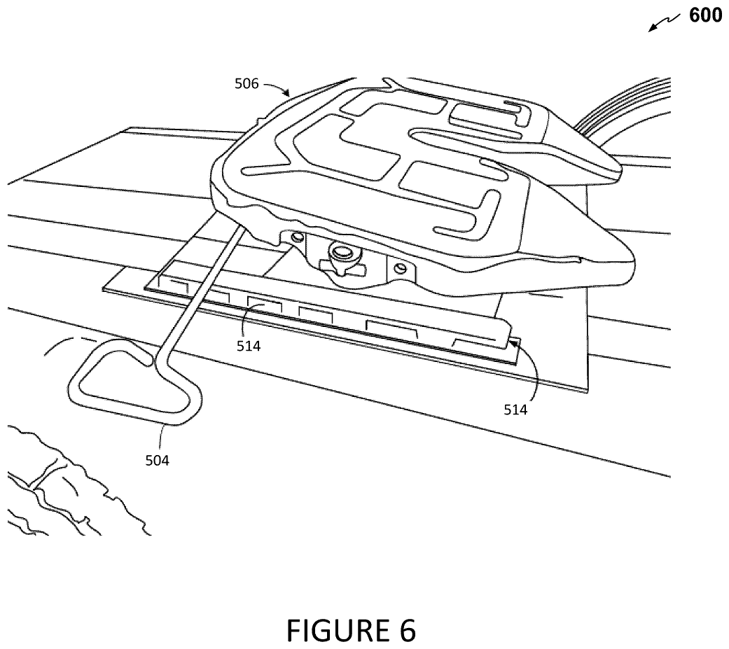

In some examples, the drive assembly 434 may also be configured to detect whether a coupling receiver 404 release lever (e.g., manual actuator) is in the locked position. FIG. 5 depicts an example of a fifth-wheel hitch 500 as viewed from a first perspective, in accordance with present implementations. FIG. 6 depicts fifth-wheel hitch 500 physically attached to a vehicle from a second perspective, in accordance with present implementations.

The fifth-wheel hitch 500 illustrated in FIGS. 5 and 6 is one example of the coupling receiver 404, which, as described above with reference to FIG. 4, can also include (e.g., in addition to the fifth-wheel hitch 500) one or more first sensor(s) 430, one or more second sensor(s) 432, and the drive assembly 434. The fifth-wheel hitch 500 includes one or more mounting point(s) 502. The mounting points 502 are configured to accept (e.g., physically receive) a bolt, fastener, or other mounting hardware to cooperatively couple the fifth-wheel hitch 500 to a mount, or base of the hitch 500. In some examples, the fifth-wheel hitch 500 can include or more portions that can be moved, slid, or otherwise repositioned, to adjust the position of the hitch 500, which may occur, in some examples, with the hitch 500 attached to the vehicle (e.g., mounted on, coupled to, or otherwise fixedly placed on, a portion of the vehicle, which may include, for example, fastening the fifth-wheel hitch to the vehicle at mounting points 502) vehicle. In some examples, the fifth-wheel hitch 500 is coupled to a moveable mount (e.g., a sliding plate) that is, in turn, physically secured to, or mounted onto, the vehicle. While a fifth-wheel hitch 500 is illustrated and described herein, it should be understood that the concepts and features of the present disclosure extend to any and all examples of the coupling receiver 404 as described herein and elsewhere.

Fifth-wheel hitch 500 further includes top plates 506. Top plates 506 are configured so as to allow the trailer to rest thereon. In some examples, top plates 506 include integrated grooves to allow for grease to be placed therein to provide lubrication between the trailer and the top plates 506. This lubrication aids rotation of the trailer with respect to the fifth-wheel hitch 500 during operation. Fifth-wheel hitch 500 includes a throat 508, into which the coupling unit (e.g., the kingpin of a trailer) may engage. Stated differently, the fifth-wheel hitch 500 can include a throat 508 that is configured to receive and lock in place or securely engage, the kingpin. Locking jaw 512 and engaging jaw 510 may cooperatively engage to lock the kingpin into the throat 508. In some examples, only one jaw 510, 512 is needed to lock the kingpin into the throat 508. According to an embodiment, the jaws 510, 512 may be autonomously engaged to lock the kingpin into the throat 508. The virtual driver system 416 of FIG. 4 may contain instructions that allow for the autonomous locking of the position of the fifth-wheel hitch 500, which may include autonomous locking the fifth-wheel hitch in one or more of the notches 514 (e.g., locking the fifth-wheel hitch in the position that at notch 516). For example, upon the processor 412 receiving a signal that one or more sensor(s) (e.g., one or more first sensors 430) has detected the presence of the fifth-wheel hitch, which may include associated objects/elements (e.g., a kingpin) at, or near, the location(s) corresponding to the sensor(s) (e.g., detecting a portion of the hitch 500 at notch 216 of the plurality of linearly disposed notches 514,) unit (e.g., the kingpin), the processor 412 may transmit a signal to the control system 420 to engage the jaws 510, 512 of FIGS. 5 and 6. Upon engaging them, the second sensor(s) 432 may transmit a signal indicating that the jaws 510, 512 are fully engaged and locked into position. The processor 412 then transmits instructions to control system 420 to allow the operation of the driveline 422, first to allow performance of the tug test and, if successful, to continue operating the vehicle according.

The configuration of the fifth-wheel hitch 500 is configured to be controlled, or managed, autonomously through the drive assembly 434 and, in some examples, using one or more actuators or other actuating elements (e.g., via a hydraulic system on vehicle 402 and configured to reposition the fifth-wheel hitch 500). For example, a hydraulic system on the vehicle 402 may use cylinders and pistons to linearly actuate, adjust, and otherwise reposition, one or more elements of the fifth-wheel hitch. For example, a hydraulic system of the vehicle 402 may be configured to adjust, or control, the position of the fifth wheel hitch at one or more notches disposed notches associated with a plurality of discrete positions. Moreover, in some examples, the hydraulic system of the vehicle 402 can close the jaws 510, 512 against each other and lock them in place. Alternatively, the configuration of the hitch 500, or any of its individual elements (e.g., jaws 510, 512, drive assembly 434, locking mechanism 426, etc.) may be controlled, adjusted, engaged, and/or physically adjusted (e.g., rotating, sliding, engaging, locking, opening, linearly repositioning, etc.) using the vehicle 402 hydraulic system.

In other examples, the jaws 510 may be actuated pneumatically (e.g., using the air compression system of vehicle 402), electromagnetically (e.g., using solenoids or relays), or electromechanically (e.g., using a motor, ball screw, lead screw, etc.). As described above, some examples may include the fifth-wheel hitch 500 with one or more sensors (e.g., one or more first sensors 430) that are each disposed at one or more notches of the plurality of linearly positioned notches 514.

For example, positioning sensors (e.g., first sensors 430, second sensors 432, etc.) may each be configured to sense the presence of the fifth-wheel hitch, or a portion thereof, (e.g., a notch connector, locking mechanism, etc.) near the location associated with that sensor (e.g., a hall-effect sensor, mounted to one of the notches 514, may detect the presence of the fifth-wheel hitch positioned at that notch). Again, as described above with reference to FIG. 4, the sensors of the fifth-wheel hitch (e.g., one or more of the first and/or second sensor(s) 430, 432) may include a plurality of inductive proximity sensors, according to one example, which may each correspond to a different notch from the linear plurality of notches 514. The inductive proximity sensors may be configured to sense the inductive capacitance of the material that forms the fifth-wheel hitch 500 (e.g., a metal coupling portion of the fifth-wheel hitch 500) that is present near the corresponding inductive proximity sensor, which can each be associated with, and configured to operate/sense at, corresponding notches of the several linearly positioned notches 514. In some examples, the hitch 500 may be detected by an inductive proximity sensor in response to the presence of hitch 500, or a portion thereof, at the notch (e.g., notch 516) corresponding to that proximity sensor. The sensor(s) (e.g., one or more first and/or second sensors 430, 432) may then transmit a signal through a data cable to a processor (e.g., processor 412 of FIG. 4). For example, the inductive proximity sensor(s) (e.g., one or more of first and/or second sensors 430, 432) may transmit an engaged, or ‘true’, status when the fifth-wheel hitch is engaged with, or present at, the notch (or notches) corresponding to those same sensors and the sensors senses the fifth-wheel hitch in, or nearby, the corresponding one or more of the notches 514. In some examples, the sensors of the hitch 500 (e.g., first and/or second sensors 430, 432) can be configured to return a non-engaged, false, or absent, status when no portion of the fifth-wheel hitch, or any other metal material, is sensed at the notch(es) corresponding to those sensors.

A manual lock sensor (e.g., of locking mechanism 426) may be configured to sense the position of locking mechanism 426. Manual lock sensor may be cooperatively coupled to the actuating mechanism or the coupling receiver 500. In either embodiment, the manual lock sensor senses an engagement of the actuating mechanism 426. In some examples, manual lock sensor is not utilized in the automatic hitch-position system. In some examples, the manual lock sensor is a backup engagement verification. Manual lock sensor is configured to sense that actuating mechanism is in an engaged position, thus eliminating the chance of a false positive reading from a jaw sensor. By verifying the overall engagement status with the one or more sensors of the hitch 500, the operator or virtual driver system may be able to ensure that the coupling unit has a position corresponding to a predetermined load balancing configuration and may determine that the coupling unit is engaged in coupling receiver 500 and locked into position. Manual lock sensor can transmit the engagement status to the processor by a data cable. As with the other sensors, the manual lock sensor may communicate with the processor wirelessly instead of by the data cable.

Returning now to FIG. 4, upon the virtual driver system 416 receiving the sensor data from sensors 430, 432, the processor 412 executing virtual driver system 416 may determine an overall engagement status of the coupling receiver 404 (e.g., coupling receiver 500 of FIGS. 5 and 6). In some examples, the signal(s) output from one or more sensor(s) may be comprised of one or more binary values. For example, either the fifth-wheel hitch is present at one of the several notches 514 or it is not present at that notch. For example, the coupling unit is either fully engaged and locked with the coupling receiver 404 or the coupling unit is not fully engaged and locked with the coupling receiver 404. In this embodiment, the first and/or second sensors 430, 432 can be configured to transmit to virtual driver system 416 a position signal for each of the linearly plurality of notches (e.g., notches 514 of FIG. 5), an engagement signal (e.g., the presence of the coupling unit, a locked position, etc.), and the like. In some examples, if one or more kingpin sensors (e.g., one or more of the first and second sensors 430, 432) transmit an engagement signal, then the virtual driver system 416 determines that the coupling receiver 404 is coupled to the coupling unit. Upon determining engagement, the processor 112, in executing the virtual driver system 416, transmits a signal to the control system 420 to allow the driveline 422 of vehicle 402 to operate. If a kingpin, or coupling unit sensors, (e.g., of the first and second sensors 430, 432) transmits a signal of non-engagement, then processor 412 may transmits a signal to the control system 420 to prevent, or otherwise disable, operation of the driveline 422 of the vehicle 402.

In some examples, a vehicle may reposition the fifth-wheel hitch 500 by disengaging the lock on the position of the fifth-wheel hitch 500 (e.g., locking mechanism 426) with the vehicle fifth-wheel hitch connected to a trailer (e.g., as detected by one or more of the first and second sensors 430, 432) and moving the vehicle until the fifth-wheel hitch falls into, or otherwise present at, the correct notches and re-engaging the lock on the position of the fifth-wheel hitch before performing a tug test.

In some examples, the virtual driver system 416 may have multiple drive modes. For example, the virtual driver system 416 may have a non-coupled mode (e.g., operating the vehicle 102 without an accessory coupled to the vehicle 402), a coupling mode (e.g., attempting to couple an accessory to the vehicle 402 via the coupling receiver 404), a coupled mode (e.g., operating the vehicle 402 when coupled to an accessory), and an override mode (e.g., to manually override the safety protocols of virtual driver system 416).

In the non-coupled mode, the virtual driver system 416 may or may not receive transmitted information from the sensors 430, 432. The virtual driver system 416 will not determine the engaged status of the sensors 430, 432 or the coupling receiver 404. The virtual driver system 416 will allow the operator or vehicle 402 to operate the vehicle 402 without restrictions. This applies to whether the vehicle 402 is manually or autonomously operated (e.g., without human intervention). The operator may selectively determine, through the user interface 440 or remote user device 436 the mode in which the vehicle 402 will be operated (whether manually or autonomously). In some examples, the controller 408 may autonomously determine what mode to operate the vehicle 402 in. The remote user device 436 or user interface 440 may display the operating mode for the operator. In some examples, the operator may choose the mode through the use of the remote user device 436 or user interface 440.

In the coupling mode, the virtual driver system 416 will begin receiving and/or communicating the engagement status from the sensors 430, 432. The processor 412 may also transmit instructions to the user interface 440 to display the engagement status to an operator of vehicle 402. The user interface 440 may then display the engagement status. The status may be displayed to the user visually (e.g., with a lock icon or unlock icon, with colors, flashing lights, text, etc.), aurally (e.g., beeping, tones, diction, etc.), or haptically (e.g., vibrations, etc.). In some examples, the user interface 440 displays to the operator the engagement status of one or more sensor(s) 430, 432. In some examples, the user interface 440 displays the overall status of the coupling unit based on the engagement status of each of the one or more sensors 430, 432.

The user interface 440 may display red when any one of the one or more sensors 430, 432 transmits a non-engaged status, an unbalanced load configuration status, or other status. Upon each transmitting an engaged status (i.e., the coupling unit is in the throat of the coupling receiver 404, the jaws of the coupling receiver 404 are fully engaged and in the locked position, and the manual release lever and actuating mechanism are in the locked and engaged position), then the display may present a green screen, a locked icon, or a green lock icon. In some examples, if at least one of the sensors 430, 432 (but not all) transmit a position corresponding to a balanced load status, ambiguous/unknown position status, position adjustment complete, and an engaged status (e.g., locking mechanism 426 engaged status, kingpin lock engaged status, etc.) then the user interface 440 may display a yellow color (e.g., display a yellow color within one or more margins or other regions of the user interface 440), one or more yellow icons, and/or one or more user notifications. In other examples, any color or icon may be used to communicate to the operator any of the engagement status of the coupling unit.

In some embodiments, the feedback to the operator regarding the engagement status of the coupling receiver 404 is aural. In this embodiment, the user interface 440 may generate various audio signals to communicate to the operator the engagement status of the coupling receiver 404. For example, upon the virtual driver system 416 being put into the coupling mode, the user interface 440 may begin beeping. Once a predetermined one or more of sensors 430, 432, transmit an engaged status, the user interface 440 may begin playing a solid tone. In some embodiments, the user interface 440 may emit diction with preselected phrases to communicate to the operator the status of one or more sensors 430, 432. For example, the user interface 440 may emit the phrase, “kingpin detected,” when the coupling unit is detected by sensors 430, 432. The user interface 440 may then emit the phrase, “jaws engaged,” when a jaw sensor senses and transmits the engagement of locking jaw 512 and/or engaging jaw 510. The user interface 440 may then provide one or more messages (e.g., emit one or more of the phrases, “manual release engaged”, “coupling receiver repositioned,” etc.) based on whether one or more of manual lock sensor, first sensors 430, second sensors 432, drive assembly 434, locking mechanism 426, and any other component(s) of the system 400, senses and transmits information regarding the configuration and/or operation of the system 400 (e.g., the position of the coupling receiver 404 and/or whether it is present near, and detected by, one or more of the sensors 430, 432). The examples described above are provided without limitation to other examples and the present disclosure is not limited thereto. Accordingly, in some examples, the virtual driver system 416 may transmit instructions to the user interface 440 to provide (e.g., emit, display, message, etc.) any phrase or other notification, in any language and in any voice, to help communicate relevant engagement information to an operator of the vehicle 402.

In some embodiments, the user interface 440 may emit haptic feedback to the operator upon entering the coupling mode. For example, upon entering into the couple mode, the user interface 440 may vibrate (either pulsing or continuously) until the sensors 430, 432 detect and transmit to the controller 408 an engaged status. Upon the sensors 430, 432 sensing and transmitting to the controller 408 an engaged status, the user interface 440 may adjust the haptic feedback to indicate an engaged status. For example, the user interface 440 may adjust from a pulsing vibration to a continuous vibration. In other examples, the user interface 440 may adjust from a continuous vibration to a pulsing vibration. In some examples, a steering mechanism is the user interface 440. In other examples, the seat is the user interface 440. However, the user interface 140 may be any device or element of the vehicle 402 or remote user device 436 to which the user is in physical contact during the coupling mode.

In some examples, the user interface 440 may communicate one or more of the previously described examples to the operator concurrently (e.g., both audio and visual communication). Upon receiving the indication during the coupling mode that the coupling unit is fully engaged and locked into the coupling receiver 404, the virtual driver system 416 may enter into the coupled mode. In some examples, the virtual driver system 416 may only enter into the coupled mode if the sensors 430, 432 are transmitting an engaged status. In autonomous examples, the virtual driver system 416 automatically enters into the coupled mode upon receiving an engaged status from sensors 430, 432 during the coupling mode.

In some examples, if the operator attempts to enter into the coupled mode from the coupling mode prior to the virtual driver system controller 408 receiving an indication of engagement, the processor 412 may transmit instructions to the control system 420 to not allow the vehicle 402 to operate beyond specified parameters (e.g., above 10 miles per hour). The operator may be required to reenter coupling mode and attempt to couple the accessory again. In some examples, the vehicle 102 may be bounded to a location (e.g., a tractor trailer hub parking lot) when in the coupling mode, and the operating parameters (e.g., speed) may be limited while in coupling mode. This may ensure that once the virtual driver system 416 enters coupling mode, the accessory is fully engaged and locked to the coupling receiver 404 prior to leaving the geofenced area. In other examples, the coupling mode does not limit vehicle 402 operating parameters or location.

When in coupled mode, any restrictions during coupling mode may be removed from vehicle 402. For example, vehicle 402 may operate at full speed and leave any geofence restrictions. The vehicle 402 may travel to its final destination with the accessory fully engaged and locked to the coupling receiver 404. However, in some examples, certain restrictions may be placed on the vehicle 402 during coupled mode to restrict maneuverability, depending on the accessory coupled to vehicle 402 via the coupling receiver 404. For example, when the vehicle 102 is a tractor trailer and the accessory is a trailer, the maximum speed of the prime mover (e.g., engine) may be limited to avoid overheating. In other examples, the maximum ground speed may be limited to allow for safe stopping distances, based on the weight of the payload of the accessory. In other examples, steering angles may be limited to avoid jackknifing the trailer. In other examples, remote operator requirements may change based on the coupled status. For example, once the vehicle 402 is in the coupled mode, a remote operator using remote user device 436 may be required to perform a safety check remotely. In other examples, an operator overseeing the autonomous operation of vehicle 402 in coupled mode may need to have certain credentials above an operator overseeing the autonomous operation of vehicle 402 in non-coupled mode. For example, a more experienced operator may be required to oversee the autonomous operation of vehicle 402 when a trailer is coupled to the vehicle 402. This may be caused by the increased risk for personal or monetary injury when operating a payload. The above examples are for example purposes only, and should not be considered limiting, and it should be understood that various other restrictions may be placed on the vehicle 402 by the virtual driver system 416 during the coupled mode.

In the override mode, the operator or autonomous system (e.g., in some examples, the virtual driver system 416) may override the safety or limiting protocols of the previous modes. For example, an operator may choose to enter into the override mode of the virtual driver system 416 to remove the geofence or speed limits of the coupling mode. In other examples, the operator or virtual driver system 416 may choose to remove the steering limits of the coupled mode to make a specific turn.

In some examples, the operator must input a code (e.g., a password) to enter into the override mode. In other examples, an operator must have certain credentials (e.g., be a manager or IT personnel) before being able to override the virtual driver system 416 safety protocols.

Turning again to FIG. 4, the sensors 430, 432 may be communicably coupled to the controller 408 or virtual driver system 416 wired or wirelessly. The wireless connection may be a wireless communication signal (e.g., Wi-Fi, cellular, LTE, 5G, etc.). In some examples, the sensors 430, 432 are communicably coupled to the controller 408 by means of the vehicle 402 bus. Additionally, the sensor data may be communicated, by the controller 408 to the network 406 by way of a network interface. Through network 406, the sensor data from sensors 430, 432 may be stored and/or accessed by database 438 and remote user device 436.

In other examples, the virtual driver system 416 need not receive an engagement signal from each sensor 430, 432 in order to transmit a signal to control system 420 to allow the driveline 122 of vehicle 402 to operate beyond predetermined parameters (e.g., above a specified speed limit). For example, a coupling receiver 404 (e.g., a fifth-wheel hitch) may not include all of the one or more first and second sensors 430, 432 described herein. Instead, the coupling receiver 404 may include only a subset of the first and second sensors 430, 432. In other examples, the virtual driver system 416 may only need two of the plurality of one or more first and second sensors 430, 132 to determine a status of the fifth-wheel hitch. For example, sensor 430 may be a backup sensor to be used if one of the other sensors is not working.

In some examples, the user interface 440 may be used to display the engagement status of sensors 430, 432. Each sensor 430, 432 may transmit its engagement status to the controller 408. Processor 412 of controller 408 may transmit instructions to display the engagement status of each sensor 430, 432 to the user interface 440. Upon receiving the instruction to display engagement status, user interface 440 may display a graphical user interface displaying the engagement status of each sensor 430, 432. In some examples, the GUI will also display an overall engagement status, depending on the combined status of each sensor 430, 432. For example, the overall engagement status may show engaged when each sensor 430, 432 transmits an engaged status. The overall engagement status may show non-engaged when at least one of the sensors 430, 432 transmits a non-engaged status. In other examples, the GUI may display the overall engagement status depending on the virtual driver system 416 protocol which determines the engagement status based on engagement status of the sensors 430, 432.

While three separate sensors 430, 432 are described in some of the examples of the present disclosure for example purposes, it should be understood that in other examples a different number of sensors may be used. For example, in some examples, only one sensor may be used. In others, two sensors may be used. In others, four or more sensors may be used. The number of sensors described in various examples should not be construed as limiting in any way.

Upon determining an engagement status, the processor 412 transmits a signal to control system 420 to allow or not allow the driveline 422 to be operated, depending on the engagement status. The control system 420 for the vehicle 402 is a system that manages and regulates the operation of various subsystems within the vehicle (e.g., prime mover 424 and locking mechanism 126). These subsystems may also include the engine, transmission, steering, brakes, and suspension, among others. The control system is responsible for monitoring the behavior of these subsystems, making adjustments as necessary, and ensuring that the vehicle operates safely and efficiently.

The control system uses various sensors (e.g., first and second sensors 430, 432) and actuators (e.g., drive assembly 434) to gather information about the state of the vehicle generally, and the configuration (e.g., position) of the fifth-wheel hitch specifically, and to make adjustments as appropriate (e.g., reposition the fifth-wheel hitch based on a position determined to correspond to a balanced load configuration). For example, a sensor might detect that the vehicle is traveling too fast and send a signal to the engine to reduce its power output. Similarly, an actuator might be used to adjust the position of the steering mechanism in response to changes in the road conditions.

In some examples, the controller 408 is integrated in control system 420. In other examples, the controller 408 and control system 420 are distinct components within vehicle 402. Control system 420 is configured to communicate information to controller 408, such as operating parameter status of the various subsystems of driveline 422 (e.g., engine speed of prime mover 424, locking action for locking mechanism 426, steering angle, temperature of prime mover 424, etc.).

In some examples, the virtual driver system 416 may be hosted on remote user device 436 or database 438. The processor 412 may access the virtual driver system 416 from database 438 or remote user device 436 through network 406. In other examples, controller 408 is integral to remote user device 436. In such examples, processor 412 transmits instructions to control system 420 through network 406 to operate the driveline 422 of vehicle 402. Virtual driver system 416 may be executed autonomously by controller 408 or may require additional user/operator input. For example, an operator of vehicle 402 may be required to accept or verify instructions from the processor 412 executing virtual driver system 416.

In some examples, the operator may override the instructions from processor 412 executing virtual driver system 416. For example, the operator may override the instructions to not allow operation of the vehicle 402 through the user interface of vehicle 402. In other examples, the operator is remote from vehicle 402 and may override the instructions by the remote user device 136.

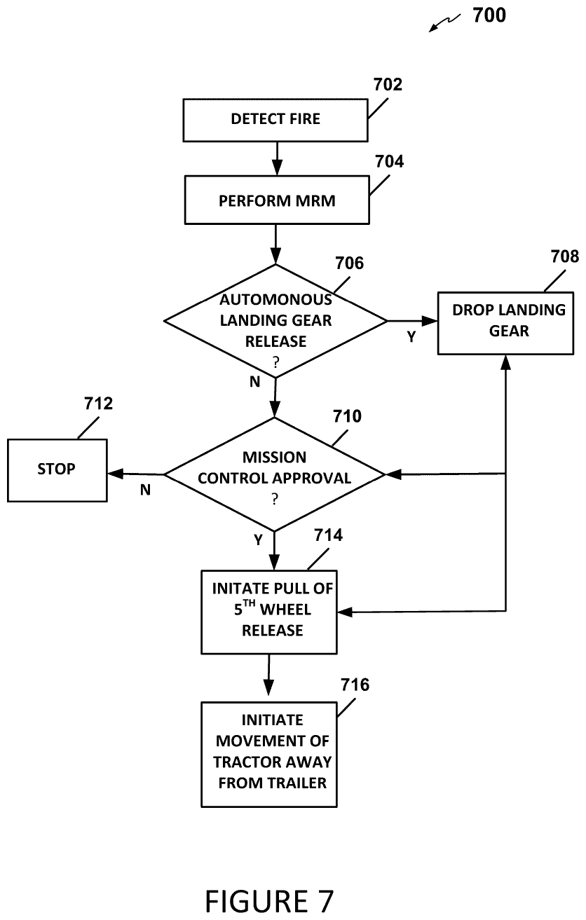

FIG. 7 is a flow diagram illustrating an embodiment of a method 700 of performing fire control processes in response to detecting a fire or imminent threat of fire. The method 700 may be performed by any of the systems described in the the preceding figures.

Turning more particularly to the flow diagram, the method 700 may detect at 702 a fire or conditions suggesting that a fire could be imminent. For example, the fire determination module 306 show in FIG. 3 may receive data from the sensors 314 that in sum indicate that a fire is present.

At 704, the method 700 may initiate one or more minimum risk maneuvers (MRMs). For example, the processors 302 of FIG. 3 may cause the semi-truck to pull over to the shoulder of a highway.

Where the trailer is equipped with an autonomous landing gear release at 706, the method 700 may include dropping the landing gear at 708. That is, the powered landing may be installed on the trailer in a manner that may be controlled by the autonomous driving circuitry, such as is depicted by the landing gear module 316 of FIG. 3. Deployment of the powered landing gear may cause a mechanical disconnection between the tractor and trailer, while providing improved stability for the disconnected trailer. This action may be initiated in some instances without prior approval from mission control center at 710.

Direction from the mission control center may be incorporated at 710 into the fire response processes of the method 700. For example, the mission control center 320 of FIG. 3 may determine at 712 that no fire control response will be performed. In one such instance, the tractor may be allowed to burn in place when deemed safest for the surrounding traffic and structures. Alternatively, the method 700 may at 714 include receiving direction from the mission control center to initiate the automated pulling of the fifth wheel release. For instance, the fire response module 312 of FIG. 3 may pull the fifth wheel release 310. In other embodiments, mission control approval may not be required to pull the fifth wheel release. For example, the release of the automated landing gear may provide sufficient stability to the trailer such that pulling the fifth wheel release presents fewer potential complications.

At 312, the method 700 may include moving the tractor away from the trailer. The movement out from under the trailer may destroy air hoses that clamp both the trailer and tractor brakes. However, the compressor and air tank on the tractor may allow it to move a safe distance (e.g., 20 ft) from the trailer before the brakes clamp down. Should the landing gear not be down, the maneuver may cause some damage to the back of the tractor, but should still allow the tractor to escape potentially catastrophic damage from the fire.

The client device as described herein may include a user equipment, a mobile device, a tablet, a smartwatch, a laptop, a smart glass, an internet-of-things (IOT) device, or a smart vehicle. The vehicle may be an autonomous vehicle, a semi-autonomous vehicle, or a non-autonomous vehicle.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A vehicle, comprising:
a locking mechanism configured to removably secure to a trailer configured to be towed;
a memory storing instructions;
one or more processors configured to access the memory and execute the instructions to:
receive at least one signal used to determine that a potential fire condition is present on at least one of the trailer or the vehicle;
in response to the at least one signal, automatically initiate unlocking the locking mechanism to disconnect the trailer; and
initiate driving a distance away from the trailer.

2. The vehicle of claim 1, wherein the locking mechanism comprises lock jaw to hold a kingpin.

3. The vehicle of claim 1, wherein the one or more processors are further configured to wirelessly communicate real-time data pertaining to the potential fire condition to a remotely located mission control center.

4. The vehicle of claim 3, wherein the one or more processors are further configured to receive the at least one signal from the mission control center.

5. The vehicle of claim 1, wherein the vehicle is at least one of an autonomous or semi-autonomous vehicle.

6. The vehicle of claim 1, wherein the one or more processors are further configured to initiate an automated release of landing gear of the trailer in response to the at least one signal.

7. The vehicle of claim 6, wherein the one or more processors are further configured to initiate unlocking the locking mechanism without permission from a remotely located mission control center in response to the automated release of the landing gear.

8. The vehicle of claim 1, wherein the at least one signal is generated by at least one of: an infrared sensor, a camera, a smoke detector, an acoustic detector, an accelerometer, and a vibration sensor, a scale, a spectral sensor, a chemical nose sensor, and a sensor on the trailer.

9. A method of responding to a potential trailer fire condition, the method comprising:
removably securing a trailer using a locking mechanism;
determining that a potential fire condition is present based on received sensor data;
in response to the determination, automatically initiating unlocking the locking mechanism to disconnect the trailer; and
initiating driving a distance away from the trailer.

10. The method of claim 9, wherein unlocking the locking mechanism further comprises moving a lock jaw of a fifth wheel assembly.

11. The method of claim 9, further comprising wirelessly communicating real-time data pertaining to the potential fire condition to a remotely located mission control center.

12. The method of claim 11, further comprising receiving instructions to unlock the locking mechanism from the mission control center.

13. The method of claim 9, further comprising initiating an automated release of landing gear of the trailer in response to the determination.

14. The method of claim 13, further comprising initiate unlocking the locking mechanism without permission from a remotely located mission control center.

15. The method of claim 13, further comprising initiate unlocking the locking mechanism in response to the automated release of the landing gear.

16. At least one computer-readable storage medium with instructions stored thereon that, in response to execution by at least one processor, cause the at least one processor to:
determine that a potential fire condition is present based on received sensor data;
in response to the determination, automatically initiate unlocking a locking mechanism connecting a trailer to be towed; and
initiate driving a distance away from the trailer.

17. The at least one computer-readable storage medium of claim 16, wherein unlocking the locking mechanism further comprises initiating movement of a lock jaw of a fifth wheel assembly.

18. The at least one computer-readable storage medium of claim 16, wherein the at least one processor is further configured to wirelessly communicate real-time data pertaining to the potential fire condition to a remotely located mission control center.

19. The at least one computer-readable storage medium of claim 18, wherein the at least one processor is further configured to receive instructions to unlock the locking mechanism from the mission control center.

20. The at least one computer-readable storage medium of claim 16, wherein the at least one processor is further configured to initiate an automated release of landing gear of the trailer in response to the determination.
